(19) United States
(12) Patent Application Publication
(10) Pub. No.: US 2014/0322519 A1
(43) Pub. Date: Oct. 30, 2014

(54) ORGANOPOLYSILOXANE COMPOSITIONS AND SURFACE MODIFICATION OF CURED SILICONE ELASTOMERS

(71) Applicant: Dow Corning Corporation, Midland, MI (US)

(72) Inventors: Dongchan Ahn, Midland, MI (US); James S. Hrabal, St. Louis, MI (US); Jeong Yong Lee, Midland, MI (US)

(21) Appl. No.: 14/356,839

(22) PCT Filed: Nov. 8, 2012
(86) PCT No.: PCT/US2012/064127

§ 371 Date: May 7, 2014

Related U.S. Application Data
(60) Provisional application No. 61/557,150, filed on Nov. 8, 2011.

(51) Int. Cl. C08G 77/38; B01D 67/00; B01D 71/70

(52) U.S. Cl. CPC C08G 77/38; B01D 71/70; B01D 67/0006; B01D 2323/30
USPC 428/312.6; 96/4; 96/10; 95/45; 95/51; 95/52; 427/400; 427/243; 428/447; 428/316.6; 428/312.8; 528/32; 525/474

(57) ABSTRACT

The present invention relates to a method of treating a surface comprising a silicone elastomer having a plurality of Si—H groups by contacting at least one region of the surface with a solution comprising a surface treatment compound, to give a treated surface with Si—OH, Si—OR, or Si—C groups. The present invention relates to a hydrosilylation-curable silicone composition. In some examples, the hydrosilylation-curable silicone composition includes an organohydrogen-polysiloxane having an average of at least forty silicon-bonded hydrogen atoms per molecule, a cross-linking agent having an average of at least two aliphatic unsaturated carbon-carbon bonds per molecule, and a hydrosilylation catalyst, wherein the mole ratio of silicon-bonded hydrogen atoms in the composition to aliphatic unsaturated carbon-carbon bonds in the composition is at least 20:1. The invention also relates to membranes, methods of making membranes, gas permeable supports for membranes, and methods of gas separation using membranes.

### CLAIM OF PRIORITY

This application claims the benefit of priority of U.S. Patent Application Ser. No. 61/557,150, entitled “ORGANOPOLYSILOXANE COMPOSITIONS AND SURFACE MODIFICATION OF CURED SILICONE ELASTOMERS,” filed on Nov. 8, 2011, which application is incorporated by reference herein in its entirety.

Silicone elastomers are useful in a variety of applications by virtue of their unique combination of properties, including high thermal stability, good moisture resistance, excellent flexibility, high ionic purity, low alpha particle emissions, and good adhesion to various substrates. However, for certain applications, the hydrophobic surface and low surface energy can be limiting aspects of the material properties of silicone elastomers. As a result, various physical and/or chemical methods of rendering the surface of silicone elastomers hydrophilic have been explored in the art, including plasma treatment (e.g., oxygen, nitrogen, argon), UV irradiation, and UV/ozone irradiation. However, these treatments are costly, time-consuming, sensitive to a variety of experimental and environmental conditions, require specialized equipment, and may result in the degradation of one or more desirable properties of the silicone elastomer. For example, exposure to the various energy sources can lead to embrittlement of the elastomer surface and the creation of low molecular weight species that can migrate to the surface and cause contamination.

Artificial membranes can be used to perform separations on a small or large scale, which makes them very useful in many settings. For example, membranes can be used to purify water, to cleanse blood during dialysis, or to separate gases or vapors. Membranes can be made by hardening or curing a composition. The use of membranes to separate gases or vapors is an important technique that can be used in many industrial procedures.

### SUMMARY OF THE INVENTION

Various embodiments of the present invention provide a hydrosilylation-curable silicone composition. The composition includes Component (A), an organohydrogenpolysiloxane having an average of at least two silicon-bonded hydrogen atoms per molecule. The composition also includes Component (B), a cross-linking agent selected from (i) at least one organosilicon compound having an average of at least two aliphatic unsaturated carbon-carbon bonds per molecule, (ii) at least one organic compound having an average of at least two aliphatic unsaturated carbon-carbon bonds per molecule, and (iii) mixtures including (i) and (ii). The composition also includes Component (C), a hydrosilylation catalyst. The mole ratio of silicon-bonded hydrogen atoms in the composition to aliphatic unsaturated carbon-carbon bonds in the composition is at least 20:1.

Various embodiments of the present invention provide a method of treating a surface. The method includes a silicone elastomer having a plurality of silicon-bonded hydrogen atoms. The method includes contacting at least one region of a surface, the surface including a silicone elastomer with a plurality of silicon-bonded hydrogen atoms, with a solution including a surface treatment compound to give a treated surface. At least one of (a), (b), or (c) occurs. In (a), the contacting occurs for a time sufficient to convert at least a portion of the silicon-bonded hydrogen atoms to silicon-bonded hydroxyl groups. In (b), the contacting occurs for a time sufficient to convert at least a portion of the silicon-bonded hydrogen atoms to silicon-bonded —O—R groups, wherein the solution further includes a compound having the formula H—O—R, wherein R is selected from C₁₋₁₅ monovalent aliphatic hydrocarbon groups, C₆₋₁₅ monovalent aromatic hydrocarbon groups, C₁₋₁₅ monovalent heteroalkyl groups, or C₁₋₁₅ monovalent heteroaryl groups, wherein R is optionally substituted with one or more halogen atoms. In (c), the contacting occurs for a time sufficient to convert at least a portion of the silicon-bonded hydrogen atoms to silicon-bonded carbon groups, wherein the solution further includes an unsaturated carboxylic acid or an unsaturated protected carboxylic acid. The surface treatment compound is selected from a platinum group metal, a platinum group metal-containing compound, a base, or a compound including Sn, Ti, or Pd. The silicone elastomer includes a cured product of a hydrosilylation-curable silicone composition.

Various embodiments of the present invention have certain advantages over other compositions, methods, and membranes. Some embodiments of the method of the present invention can be a milder method of increasing the hydrophilicity of the treated surface. Some embodiments can be a more selective method of increasing the hydrophilicity of the treated surface, for example by having a preference to predominantly cause chemical transformations of the particular desired chemical moieties at the surface while causing minimal or no collateral damage such as embrittlement or the formation of low molecular weight species through degradation. Some embodiments can be a more cost-effective method of increasing the hydrophilicity of the treated surface, for example by costing less to perform or by having greater effectiveness. Additionally, in some embodiments the technique is amenable to patterning of the surface modification without the need for extensive surface masking procedures by use of direct application techniques such as stamping or inkjet printing. In some embodiments, the silicone composition of the present invention can be used to generate materials with beneficial and unexpected properties, for example, membranes with high free volume, high permeability for particular gases, and high selectivity for particular gases. In some embodiments, the surface treatment method can render cured silicone articles paintable with conventional water or oil based inks, improve adhesion, direct the flow of water or water-borne materials, direct growth of proteins, or aid in the seeding of crystals.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1a illustrates normalized Si—H intensity versus immersion time, in accordance with various embodiments.

FIG. 1b illustrates normalized Si—H intensity versus immersion time, in accordance with various embodiments.

FIG. 2a illustrates normalized Si—H intensity versus immersion time, in accordance with various embodiments.

FIG. 2b illustrates normalized Si—H intensity versus immersion time, in accordance with various embodiments.

FIG. 3 illustrates an ATR-IR spectral overlay of elastomer surface, in accordance with various embodiments.

FIG. 4 illustrates a spectral overlay of an elastomer surface, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y.” Likewise, the statement “about X, Y, or about Z” has the same meaning as “about X, about Y, or about Z.”

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. Examples include acyl, cycloalkyl, aryl, aralkyl, heterocyclyl, heteroaryl, or heteroarylalkyl, linear and/or branched groups such as alkyl groups, fully or partially halogen-substituted haloalkyl groups, alkenyl groups, alkynyl groups, acrylate and methacrylate functional groups; and other organic functional groups such as ether groups, cyanate ester groups, ester groups, carboxylate salt groups, and masked isocyano groups.

The term “resin” as used herein refers to polysiloxane material of any viscosity that includes at least one siloxane monomer that is bonded via a Si—O—Si bond to three or four other siloxane monomers. In one example, the polysiloxane material includes T or Q groups, as defined herein.

The term “cure” as used herein refers to exposing to radiation in any form, heating, or allowing to undergo a physical or chemical reaction that results in hardening or an increase in viscosity.

The term “free-standing” or “unsupported” as used herein refers to a membrane with the majority of the surface area on each of the two major sides of the membrane not contacting a substrate, whether the substrate is porous or not. In some embodiments, a membrane that is “free-standing” or “unsupported” can be 100% not supported on both major sides. A membrane that is “free-standing” or “unsupported” can be supported at the edges or at the minority (e.g. less than about 50%) of the surface area on either or both major sides of the membrane.

The term “supported” as used herein refers to a membrane with the majority of the surface area on at least one of the two major sides contacting a substrate, whether the substrate is porous or not. In some embodiments, a membrane that is “supported” can be 100% supported on at least one side. A membrane that is “supported” can be supported at any suitable location at the majority (e.g. more than about 50%) of the surface area on either or both major sides of the membrane.

The term “enrich” as used herein refers to increasing in quantity or concentration, such as of a liquid, gas, or solute. For example, a mixture of gases A and B can be enriched in gas A if the concentration or quantity of gas A is increased, for example by selective permeation of gas A through a membrane to add gas A to the mixture, or for example by selective permeation of gas B through a membrane to take gas B away from the mixture.

The term “deplete” as used herein refers to decreasing in quantity or concentration, such as of a liquid, gas, or solute. For example, a mixture of gases A and B can be depleted in gas B if the concentration or quantity of gas B is decreased, for example by selective permeation of gas B through a membrane to take gas B away from the mixture, or for example by selective permeation of gas A through a membrane to add gas A to the mixture.

The term “selectivity” or “ideal selectivity” as used herein refers to the ratio of permeability of the faster permeating gas over the slower permeating gas, measured at room temperature.

The term “permeability” as used herein refers to the permeability coefficient (Pₓ) of substance X through a membrane, where qₘₓ=Pₓ*A*Δpₓ*(1/δ), where qₘₓ is the volumetric flow rate of substance X through the membrane, A is the surface area of one major side of the membrane through which substance X flows, Δpₓ is the difference of the partial pressure of substance X across the membrane, and δ is the thickness of the membrane. Pₓ can also be expressed as V·δ/(A·t·Δp), wherein Pₓ is the permeability for a gas X in the membrane, V is the volume of gas X which permeates through the membrane, δ is the thickness of the membrane, A is the area of the membrane, t is time, Δp is the pressure difference of the gas X at the retente and permeate side. Permeability is measured at room temperature, unless otherwise indicated.

The term “Barrer” or “Barrers” as used herein refers to a unit of permeability, wherein 1 Barrer=10⁻¹¹ (cm³ gas) cm cm⁻² s⁻¹ mmHg⁻¹, or 10⁻¹⁰ (cm³ gas) cm cm⁻² s⁻¹ cm Hg⁻¹, where “cm³ gas” represents the quantity of the gas that would take up one cubic centimeter at standard temperature and pressure.

The term “surface” refers to a boundary or side of an object, wherein the boundary or side can have any perimeter shape and can have any three-dimensional shape, including flat, curved, or angular, wherein the boundary or side can be continuous or discontinuous.

The term “mil” as used herein refers to a thousandth of an inch, such that 1 mil=0.001 inch.

The term “silicone elastomer” as used herein refers to a cured product of any curable silicone-containing composition.

The term “hydrocarbon” as used herein refers to any hydrocarbon group, linear or branched, such as any alkyl, aryl, cycloalkyl, aliphatic, or aromatic group.

The present invention relates to a method of treating a surface including a silicone elastomer having a plurality of silicon-bonded hydrogen atoms by contacting at least one region of the surface with a solution including a surface treatment compound. In one example, the solution including a surface treatment compound includes an aqueous solution of a platinum group metal-containing catalyst. The present invention relates to a hydrosilylation-curable silicone composition. In some examples, the hydrosilylation-curable silicone composition includes an organohydrogen-polysiloxane having an average of at least forty silicon-bonded hydrogen atoms per molecule, a cross-linking agent having an average of at least two aliphatic unsaturated carbon-carbon bonds per molecule, and a hydrosilylation catalyst, wherein the mole ratio of silicon-bonded hydrogen atoms in the organohydrogenpolysiloxane to aliphatic unsaturated carbon-carbon bonds in the cross-linking agent is at least 20:1. The invention also relates to membranes, methods of making membranes, gas permeable supports for membranes, and methods of gas separation using membranes.

Treating the surface of a silicone elastomer having a plurality of silicon-bonded hydrogen atoms with a solution including a surface treatment compound can be a mild, selective, and cost-effective method of increasing the hydrophilicity of the treated surface.

### Hydrosilylation-Curable Silicone Composition

Various embodiments of the present invention provide a hydrosilylation-curable silicone composition. The hydrosilylation-curable composition can be any suitable hydrosilylation-curable composition known to one of skill in the art. Before curing (e.g. before the reaction product or curing product is formed), the hydrosilylation-curable composition of the present invention can include an organohydrogenpolysiloxane (Component (A)), a cross-linking agent (Component (B)), and a hydrosilylation catalyst (Component (C)). The silicone composition can include any suitable additional ingredients, including any suitable organic or inorganic component, including components that do not include silicon, including components that do not include a polysiloxane structure.

During a hydrosilylation curing process, Si—H bonds add across unsaturated bonds, such as across alkenyl or alkynyl groups. The hydrosilylation-curable composition can include an organopolysiloxane that includes at least one Si—H bond per molecule. The hydrosilylation-curable composition can include a cross linking agent with at least one unsaturated bond per molecule. In some embodiments, hydrosilylation-curable mixtures can include other components having at least one Si—H bond or at least one unsaturated bond other than the organopolysiloxane and the cross-linking agent. In some embodiments, the organopolysiloxane includes both at least one Si—H bond and at least one unsaturated bond. In some embodiments, some organopolysiloxanes in the composition include at least one Si—H bond, while other organopolysiloxanes in the composition include at least one unsaturated bond. All combinations and permutations of Si—H bonds and unsaturated bonds as being part of the organopolysiloxane, as being part of another component (e.g. the cross-linking agent), or as being both present on a single component, are encompassed as embodiments of the present invention.

The hydrosilylation-curable composition includes Component (A), an organohydrogenpolysiloxane. The organohydrogenpolysiloxane can be present in from about 5 wt % to about 99 wt %, about 8 wt % to about 98 wt %, about 10 wt % to about 96 wt %, or about 15 wt % to 95 wt % of the uncured composition. In some embodiments, the organohydrogenpolysiloxane can be present in from about 10 wt % to about 50 wt %, about 15 wt % to about 45 wt %, 20 wt % to about 35 wt %, or about 25 wt % to 31%, or about 28 wt % of the uncured composition. In some embodiments, the organohydrogenpolysiloxane can be present in from about 30 wt % to about 70 wt %, about 40 wt % to about 60 wt %, 45 wt % to about 55 wt %, or about 48 wt % to 52 wt %, or about 50 wt % of the uncured composition. In some embodiments, the organohydrogenpolysiloxane can be present in from about 60 wt % to about 99 wt %, about 70 wt % to about 96 wt %, or about 80 wt % to about 95 wt % or about 86 wt % to about 94 wt % or about 88 wt % to about 92 wt %, or about 90 wt % of the uncured composition. Wt% in this paragraph refers to the percent by weight based on the total weight of the hydrosilylation-reactive components of the uncured composition, including at least Components (A), (B), and (C).

The hydrosilylation-curable composition includes Component (B), a cross-linking agent. The cross-linking agent can be present in from about 0.5 wt % to about 99 wt %, about 1 wt % to about 90 wt %, or about 3 wt % to 80 wt % of the uncured composition. In some embodiments, the cross-linking agent can be present in from about 50 wt % to about 99 wt %, about 60 wt % to about 80 wt %, or about 70 wt % to about 75 wt %, or about 72 wt % of the uncured composition. In some embodiments, the cross-linking agent can be present in from about 25 wt % to about 75 wt %, about 40 wt % to about 60 wt %, or about 48 wt % to about 52 wt %, or about 50 wt % of the uncured composition. In some embodiments, the cross-linking agent can be present in from about 1 wt % to about 20 wt %, about 5 wt % to about 15 wt %, or about 8 wt % to about 10 wt %, or about 9 wt % range of the uncured composition. Wt% in this paragraph refers to the percent by weight based on the total weight of the hydrosilylation-reactive components of the uncured composition, including at least Components (A), (B), and (C).

The hydrosilylation-curable composition includes Component (C), a hydrosilylation catalyst. The hydrosilylation catalyst can be present in from about 0.00001 wt % to about 20 wt %, about 0.001 wt % to about 10 wt %, or about 0.01 wt % to about 3 wt % of the uncured composition. In some embodiments, the hydrosilylation catalyst can be present in from about 0.001 wt % to about 3 wt %, about 0.01 wt % to about 1 wt %, or about 0.1 wt % to about 0.3 wt % of the uncured composition. Wt% in this paragraph refers to the percent by weight based on the total weight of the hydrosilylation-reactive components of the uncured composition, including at least Components (A), (B), and (C).

### Component (A), Organohydrogenpolysiloxane Having Silicon-Bonded Hydrogen Atoms

The reaction mixture can include Component (A), an organohydrogenpolysiloxane including a silicon-bonded hydrogen atom. In some examples, the organohydrogenpolysiloxane compound has an average of at least two, or more than two silicon-bonded hydrogen atoms. The organopolysiloxane compound can have a linear, branched, cyclic, or resinous structure. The organopolysiloxane compound can be a homopolymer or a copolymer. The organopolysiloxane compound can be a disiloxane, trisiloxane, or polysiloxane. The silicon-bonded hydrogen atoms in the organosilicon compound can be located at terminal, pendant, or at both terminal and pendant positions.

In various embodiments, the organohydrogenpolysiloxane compound can have an average of less than about 5, or at least about 5, 10, 15, 20, 25, 30, 35, 40, 45, 50, 55, 60, 65, 70, 80, 100, 200, or greater than about 200 Si—H units per molecule. In some embodiments, the organohydropolysiloxane compound has an average of about 40 Si—H units per molecule.

In one example, an organohydrogenpolysiloxane can include a compound of the formula

R^{x}₃SiO(R^{x}₂SiO)_{α}(R^{x}R²SiO)_{β}SiR^{x}₃, or (a)

R⁴R^{x}₂SiO(R^{x}₂SiO)_{χ}(R^{x}R⁴SiO)_{δ}SiR^{x}₂R⁴. (b)

In formula (a), α has an average value of about 0 to about 500,000, and β has an average value of about 2 to about 500,000. Each R^{x} is independently a monovalent functional group. Suitable monovalent functional groups include, but are not limited to, acrylic groups; alkyl; halogenated hydrocarbon groups; alkenyl; alkynyl; aryl; and cyanoalkyl. Each R² is independently H or R^{x}. In some embodiments, β is less than about 20, is at least 20, 40, 150, or is greater than about 200. In formula (b), χ has an average value of 0 to 500,000, and δ has an average value of 0 to 500,000. Each R^{x} is independently as described above. Each R⁴ is independently H or R^{x}. In some embodiments, δ is less than about 20, is at least 20, 40, 150, or is greater than about 200.

Examples of organohydrogenpolysiloxanes can include compounds having the average unit formula

(R^{x}R⁴R⁵SiO_{1/2})_{w}(R^{x}R⁴SiO_{2/2})ₓ(R⁴SiO_{3/2})_{y}(SiO_{4/2})_{z} (I),

wherein R^{x} is independently as defined above, R⁴ is H or R^{x}, R⁵ is H or R^{x}, 0≦w<0.95, 0≦x<1, 0≦y<1, 0≦z<0.95, and w+x+y+z=1. In some embodiments, R¹ is C₁₋₁₀ hydrocarbyl or C₁₋₁₀ halogen-substituted hydrocarbyl, both free of aliphatic unsaturation, or C₄ to C₁₄ aryl. In some embodiments, w is from 0.01 to 0.6, x is from 0 to 0.5, y is from 0 to 0.95, z is from 0 to 0.4, and w+x+y+z=1.

### Component (B), Cross-Linking Agent

The hydrosilylation-curable silicone composition of the present invention can include Component (B), a crosslinking agent. The crosslinking agent can be any suitable crosslinking agent. In one embodiment, the crosslinking agent can include (i) at least one organosilicon compound having an average of at least two unsaturated aliphatic carbon-carbon bonds per molecule (e.g. at least two alkenyl or alkynyl groups per molecule), (ii) at least one organic compound having an average of at least two unsaturated aliphatic carbon-carbon bonds per molecule (e.g. two alkenyl or alkynyl groups per molecule), or (iii) a mixture including (i) and (ii).

Component (B) can be present in any suitable concentration. In some embodiments, Component (B) can be present in sufficient concentration to allow at least partial curing of the silicone composition. In some examples, there are at least about 1, 5, 10, 15, 20, 30, 40, 50, 60, 70, 80, 90, 100, 150, 200, or greater than about 200 moles of silicon-bonded hydrogen atoms, per mole of aliphatic unsaturated carbon-carbon bonds in the silicone composition. In some embodiments, the mole ratio of silicon-bonded hydrogen atoms in Component (A) is at least about 1, 5, 10, 15, 20, 30, 40, 50, 60, 70, 80, 90, 100, 150, 200, or greater than about 200 per mole of aliphatic unsaturated carbon-carbon bonds in Component (B).

### Component (B), (i), at Least One Organosilicon Compound Having an Average of at Least Two Aliphatic Unsaturated Carbon-Carbon Bonds per Molecule

The hydrosilylation-curable silicone composition of the present invention can include an organosilicon compound having an average of at least two aliphatic unsaturated carbon-carbon bonds per molecule. The organosilicon compound having an average of at least two aliphatic unsaturated carbon-carbon bonds per molecule can be any suitable organosilicon compound having an average of at least two unsaturated carbon-carbon bonds per molecule, wherein each of the two unsaturated carbon-carbon bonds is independently or together part of a silicon-bonded group. In some embodiments, the organosilicon compound having an average of at least two aliphatic unsaturated carbon-carbon bonds per molecule can be an organosilicon compound with at least two silicon-bonded aliphatic unsaturated carbon-carbon bond-containing groups. In some embodiments, the organosilicon compound has at least three aliphatic unsaturated carbon-carbon bonds per molecule.

The organosilicon compound can be an organosilane or an organosiloxane. The organosilane can be a monosilane, disilane, trisilane, or polysilane, and the organosiloxane can be a disiloxane, trisiloxane, or polysiloxane. The structure of the organosilicon compound can be linear, branched, cyclic, or resinous. Cyclosilanes and cyclosiloxanes can have from 3 to 12 silicon atoms. In acyclic polysilanes and polysiloxanes, the aliphatic unsaturated carbon-carbon bonds can be located at least one of terminal and pendant positions.

Examples of organosilanes suitable for use as component (B)(i) include, but are not limited to, silanes having the following formulae: Vi₄Si, PhSiVi₃, MeSiVi₃, PhMeSiVi₂, Ph₂SiVi₂, and PhSi(CH₂CH═CH₂)₃, where Me is methyl, Ph is phenyl, and Vi is vinyl.

Examples of aliphatic unsaturated carbon-carbon bond-containing groups can include alkenyl groups such as vinyl, allyl, butenyl, and hexenyl; alkynyl groups such as ethynyl, propynyl, and butynyl; or acrylate-functional groups such as acryloyloxyalkyl or methacryloyloxypropyl.

In some embodiments, Component (B), (i) is an organopolysiloxane of the formula

R^{y}₃SiO(R^{y}₂SiO)_{α}(R^{y}R²SiO)_{β}SiR^{y}₃, (a)

R^{y}₂R⁴SiO(R^{y}₂SiO)_{χ}(R^{y}R⁴SiO)_{δ}SiR^{y}₂R⁴, (b)

or combinations thereof.

In formula (a), α has an average value of 0 to 2000, and β has an average value of 1 to 2000. Each R^{y} is independently a monovalent organic group, such as those listed for R^{x} herein, or acrylic functional groups such as acryloyloxypropyl and methacryloyloxypropyl; alkenyl groups such as vinyl, allyl, and butenyl; alkynyl groups such as ethynyl and propynyl; aminoalkyl groups such as 3-aminopropyl, 6-aminohexyl, 11-aminoundecyl, 3-(N-allylamino)propyl, N-(2-aminoethyl)-3-aminopropyl, N-(2-aminoethyl)-3-aminoisobutyl, p-aminophenyl, 2-ethylpyridine, and 3-propylpyrrole; epoxyalkyl groups such as 3-glycidoxypropyl, 2-(3,4-epoxycyclohexyl)ethyl, and 5,6-epoxyhexyl; isocyanate and masked isocyanate functional groups such as 3-isocyanatopropyl, tris-3-propylisocyanurate, propyl-t-butylcarbamate, and propylethylcarbamate; aldehyde functional groups such as undecanal and butyraldehyde; anhydride functional groups such as 3-propyl succinic anhydride and 3-propyl maleic anhydride; carboxylic acid functional groups such as 3-carboxypropyl and 2-carboxyethyl; and metal salts of carboxylic acids such as the Zn, Na or K salts of 3-carboxypropyl and 2-carboxyethyl. Each R² is independently an unsaturated monovalent aliphatic carbon-carbon bond-containing group, as described herein, or R^{y}. In formula (b), χ has an average value of 0 to 2000, and δ has an average value of 1 to 2000. Each R^{y} is independently as defined above, and R⁴ is independently the same as defined for R² above.

Examples of organopolysiloxanes having an average of at least two aliphatic unsaturated carbon-carbon bonds per molecule include compounds having the average unit formula

(R¹R²R³SiO_{1/2})ₐ(R⁴R⁵SiO_{2/2})_{b}(R⁶SiO_{3/2})_{c}(SiO_{4/2})_{d} (I)

wherein R¹, R², R³, R⁴, R⁵, and R⁶ are organic groups independently selected from R^{y} or R² as defined above, 0≦a<0.95, 0≦b<1, 0≦c<1, 0≦d<0.95, a+b+c+d=1.
Component (B), (ii), at Least One Organic Compound Having an Average of at Least Two Aliphatic Unsaturated Carbon-Carbon Bonds per Molecule

The hydrosilylation-curable silicone composition of the present invention can include an organic compound having an average of at least two aliphatic unsaturated carbon-carbon bonds per molecule, such as alkenyl or alkynyl groups, for example. Embodiments of the organic compound having an average of at least two aliphatic unsaturated carbon-carbon bonds per molecule include any organosilicon compound having an average of at least two aliphatic unsaturated carbon-carbon bonds per molecule disclosed in the section above, Component (B)(i).

Component (B)(ii) is at least one organic compound having an average of at least two aliphatic unsaturated carbon-carbon bonds per molecule. The organic compound can be any organic compound containing at least two aliphatic unsaturated carbon-carbon bonds per molecule, provided the compound does not prevent the organohydrogenpolysiloxane of the silicone composition from curing to form a cured product. The organic compound can be a diene, a triene, or a polyene. Also, the unsaturated compound can have a linear, branched, or cyclic structure. Further, in acyclic organic compounds, the unsaturated carbon-carbon bonds can be located at terminal, pendant, or at both terminal and pendant positions. Examples can include 1,4-butadiene, 1,6-hexadiene, 1,8-octadiene, and internally unsaturated variants thereof.

The organic compound can have a liquid or solid state at room temperature. Also, the organic compound can be soluble in the silicone composition. In some embodiments, the organic compound has a normal boiling point greater than the cure temperature of the organohydrogenpolysiloxane, which can help prevent removal of appreciable amounts of the organic compound via volatilization during cure. The organic compound can have a molecular weight less than 500, 400, or less than 300.

In one example, the organic compound having an average of at least two alkenyl groups per molecule is a polyether having at least two aliphatic unsaturated carbon-carbon bonds per molecule, or a halogen-substituted variant thereof.

### Component (C), Hydrosilylation Catalyst

The silicone composition in its pre-cured state includes at least one hydrosilylation catalyst. During curing of the silicone composition, the hydrosilylation catalyst can catalyze an addition reaction (hydrosilylation) of the organohydrogenpolysiloxane with the cross-linking agent. In some embodiments, the hydrosilylation catalyst can be any hydrosilylation catalyst including a platinum group metal or a compound containing a platinum group metal. Platinum group metals include platinum, rhodium, ruthenium, palladium, osmium and iridium. The platinum group metal can be platinum.

Examples of hydrosilylation catalysts include the complexes of chloroplatinic acid and certain vinyl-containing organosiloxanes disclosed by Willing in U.S. Pat. No. 3,419,593, such as the reaction product of chloroplatinic acid and 1,3-divinyl-1,1,3,3-tetramethyldisiloxane; microencapsulated hydrosilylation catalysts including a platinum group metal encapsulated in a thermoplastic resin, as exemplified in U.S. Pat. No. 4,766,176 and U.S. Pat. No. 5,017,654; and photoactivated hydrosilylation catalysts, such as platinum(II) bis(2,4-pentanedioate), as exemplified in U.S. Pat. No. 7,799,842. An example of a suitable hydrosilylation catalyst includes a platinum(IV) complex of 1,3-diethenyl-1,1,3,3-tetramethyldisiloxane.

### Method of Treating a Surface

Various embodiments of the present invention provide a method of treating a surface. The surface can have a plurality of silicon-bonded hydrogen atoms. The treatment can decrease the number of silicon-bonded hydrogen atoms, while increasing the number Si—OH groups, Si—OR groups, or Si—C groups. The treatment can decrease the hydrophobicity of the surface, and thereby increase the hydrophilicity thereof. In various embodiments, the method of treating a surface provided by the present invention is a mild, selective and cost-effective method of making the surface of a cured siloxane elastomer hydrophilic.

In one embodiment, a method of treating a surface is provided. The surface includes a silicone elastomer. The silicone elastomer can include a plurality of silicon-bonded hydrogen atoms. The method includes contacting at least one region of the surface with a solution that includes a surface treatment compound. In various embodiments, more than one discrete region of the surface is contacted with the solution comprising the surface treatment compound. The contacting can occur for an amount of time sufficient to convert at least a portion of the silicon-bonded hydrogen atoms to silicon-bonded hydroxyl groups.

In some embodiments, the silicone elastomer can be any suitable silicone elastomer that includes a plurality of silicon-bonded hydrogen atoms. The silicon-bonded hydrogen atoms can occur at or near the surface of the silicone elastomer. Any silicon-bonded hydrogen atom that can be accessed by the treatment can be included in the plurality of silicon-bonded hydrogen atoms. Any part of the silicone elastomer that can be accessed by the treatment can be included in the surface of the silicone elastomer. The surface includes at least one silicon-bonded hydrogen atom.

In some examples, the silicone elastomer can be a reaction product or a cured product of a curable silicone composition. In an example, the silicone composition is a hydrosilylation-curable silicone composition. In various embodiments, the silicone composition can be the hydrosilylation-curable silicone composition provided by embodiments of the present invention including Components (A), (B), and (C).

The method can include contacting at least one region of the surface of the silicone elastomer with the treatment solution. During the contacting, the number of Si—H bonds decrease, and the number of Si—OH, Si—OR, or Si—C bonds increase. The contacting can be any suitable contacting. The contacting can be immersion in the treatment solution. The contacting can include spreading the solution on the surface in any suitable fashion, such as by brushing, pipetting, dripping, spraying, dipping, or the like. The contacting can occur for any suitable duration of time, such that the number of silicon-bonded hydrogen atoms on the treated surface is decreased. For example, the duration of contacting can be about 1 s, 10 s, 20 s, 30 s, 1 m, 2 m, 5 m, 10 m, 20 m, 30 m, 40 m, 50 m, 60 m, 2 h, 4 h, 8 h, 16 h, 24 h, 2 d, or about 4 d. The contacting can occur at any suitable temperature, such that the number of silicon-bonded hydrogen atoms on the treated surface is decreased. For example, the contacting can occur at room temperature. In other examples, the contacting can occur at less than room temperature, or at greater than room temperature. In some examples, the contacting can occur at about −20° C., −10° C., 0° C., 10° C., 20° C., 30° C., 40° C., 50° C., 60° C., 70° C., 80° C., 90° C., or about 100° C.

The silicone elastomer can include any number of surfaces. The treated region of the surface can be any region of the surface of the silicone elastomer. The region can be any suitable size, include about the entire surface, about 75%, about 50%, about 25%, about 1% of the surface, or less than 1% of the surface. The region can be a single region. The region can be the entire surface. The region can be less than the entire surface, for example about 75%, about 50%, about 25%, about 1%, or about less than 1% of the entire surface. The region can be a combination of regions, such as adjacent regions, or nonadjacent regions. In some examples, the region can be a pattern on the surface, for example by using by droplets of the treatment solution.

The surface treatment solution is a solution that can include at least a surface treatment compound and, optionally, a solvent. The surface treatment compound can be any suitable surface treatment compound, as described herein. The solvent can be any suitable solvent. For example, the solvent can be water. In another example, the solvent can be an organic solvent. The solvent can be any suitable organic solvent. The solution can include more than one solvent. The solution can include water and a co-solvent.

In one example, the method includes immersing a hydrosilylation-cured elastomer that includes a plurality of residual Si—H groups in an aqueous solution of chloroplatinic acid which converts at least some of the surface Si—H groups to Si—OH groups.

In one embodiment of the present invention, the solution further includes an alcohol having the formula H—O—R, wherein R is any suitable organic group as described herein. Treatment with such a solution for a sufficient time allows conversion of at least a portion of the Si—H groups to Si—O—R groups, with the R-groups derived from the alcohol having the formula H—O—R.

In one embodiment of the present invention, the solution further includes an unsaturated carboxylic acid or an unsaturated protected carboxylic acid. Treatment with such a solution allows hydrosilylation of Si—H groups across the unsaturated groups in the unsaturated carboxylic acid or in the unsaturated protected carboxylic acid. Thus, treatment with such a solution for sufficient time allows conversion of at least a portion of the Si—H groups to Si—C groups, wherein the carbon groups are derived from the unsaturated carboxylic acid or the unsaturated protected carboxylic acid. The unsaturated carboxylic acid can be any suitable unsaturated carboxylic acid, and the unsaturated protected carboxylic acid can be any suitable unsaturated protected carboxylic acid. For example, the carboxylic acid can be any C₁₋₂₀ alkenoic acid. For example, the carboxylic acid can be undecylenic acid, itaconic acid, acrylic acid, or methacrylic acid.

In some examples, the protecting group can be removed via hydrolysis, to give a carboxylic acid. Thus, in some examples, the protected carboxylic acid can be a hydrolysable derivative of a carboxylic acid. For example, the protected carboxylic acid can be an ester, an amide, a nitrile, or an anhydride. In some examples, the protecting group can be removed by other steps, such as more than one step, such as via dehydration, oxidation, desilylation, or any suitable deprotecting procedure. In some examples, the protecting group can be an orthoester, an orthoacid, a silylester, or an oxazoline. Carboxylic acid protecting groups and methods of removal are well-known in the art.

In some examples, the carboxylic acid groups can be allowed to react with carboxylic acid-reactive groups. This can allow the addition of further functionalization on the surface of the treated silicone elastomer. For example, the carboxylic acid groups can be allowed to react with amine compounds to generate a subsequent layer on the surface.

The treated silicone elastomer surface can have many different uses. In one example, the treatment can render the surface more compatible to seeding of crystals that ordinarily lack binding affinity to an unmodified silicone surface. In another example, the treatment can enable the synthesis of gas permeable supports for deposition of membranes, as described further below. In another example, the treated silicone elastomer can be rendered markable or paintable with inks or paints, including conventional water or oil based inks or paints or solventless inks or paints, such that the ink or paint can wet the surface without beading, wherein prior to treatment wetting of the surface with the paint or ink was difficult or impossible. Advantageously, this allows avoiding traditional methods of rendering surfaces paintable such as costly, potentially damaging high energy surface treatment processes such as plasma, corona, flame or UV-ozone treatments.

In some embodiments, while the treatment solution reacts with the surface, the method can further include the presence of an overlayer or patterned stamp to prevent dewetting of the composition. In some embodiments, after the reaction of the treatment solution with the surface, the method can include removing the excess composition and the optional overlayer or patterned stamp.

### Surface Treatment Compound

The surface treatment compound can be any suitable compound that facilitates a chemical reaction causing Si—H groups to be converted to Si—OH groups, Si—OR groups, or Si—C groups. The chemical reaction can occur with any number of intermediate steps. In one example, the chemical reaction facilitated by the surface treatment compound is catalytic, such that the surface treatment compound increases the rate of the reaction of Si—H groups to other groups without being itself consumed. In another example, the chemical reaction facilitated by the surface treatment compound is not catalytic, such that reaction of Si—H groups to other groups is caused or aided by the surface treatment compound, and the surface treatment compound itself is consumed in the process of facilitating the reaction.

The surface treatment compound can be any suitable surface treatment compound. For example, the surface treatment compound can include a platinum-group metal-containing compound. In one example, the platinum-group metal-containing compound is chloroplatinic acid. In some examples, chloroplatinic acid is catalytic. In other examples, the surface treatment compound can be a catalyst or compound that includes Sn, Ti, or Pd.

The surface treatment compound is present in a solution. The solution includes a surface treatment compound and a suitable solvent. In some examples, the surface treatment solution has sufficient platinum-group metal-containing compound such that the solution has at least 1 ppm of the platinum-group metal. In other examples, the surface treatment solution has at least 5 ppm, 10 ppm, 20 ppm, 40 ppm, 60 ppm, 75 ppm, 100 ppm, 150 ppm, 200 ppm, 250 ppm, 300 ppm, 450 ppm, 500 ppm, 1000 ppm, 2000 ppm, or any suitable ppm of Pt or other metal.

In another example, the surface treatment compound can be any suitable base. For example, the base can be a salt such as KOH, NaOH, Ba(OH)₂, CsOH, Sr(OH)₂, Ca(OH)₂, Mg(OH)₂, LiOH, or RbOH. In another example, the base can be an organic base such as, for example, a pyridine, imidazole, benzimidazole, histidine, or a phosphazene base. Examples can include butyl lithium, lithium diisopropylamine, lithium diethylamine, sodium amide, sodium hydride, or lithium bis(trimethylsilyl) amide. In another example, the base can be an organic base such as an amine, such as any amine including a primary, secondary, or tertiary amine, including for example, ammonia, triethylamine, methylamine, dimethylamine, N,N-diisopropylethylamine, any mono-, di-, or trialkyl substituted amine, and the like. The concentration of the base can be any suitable concentration. For example, the concentration of the base can be about 0.000,000,000,000,001 g/mL, 0.000,000,000,001 g/mL, or about 0.000,000,001 g/mL, 0.000,001 g/mL, 0.000,01 g/mL, 0.000,1 g/mL, 0.001 g/mL, 0.01 g/mL, 0.1 g/mL,or about 1 g/ml.

### Method of Making a Porous or Highly Permeable Substrate

Various embodiments of the present invention provide a method of making a porous or highly permeable substrate. Porous or highly permeable substrates, and uses thereof, are described herein. The method can include treating the surface of any material that includes Si—H groups using the method of surface treatment described herein to give a porous or highly permeable substrate that has a decreased amount of Si—H groups at the surface, and an increased amount of Si—OH, Si—OR, or Si—C groups at the surface. The substrate can be any suitable material that includes Si—H groups on at least one surface, wherein the surface is any part of the substrate that can be reached by the method of treatment of a surface described herein. The treatment gives a treated substrate.

### Membrane

In various embodiments, the present invention provides a membrane that includes a reaction product or cured product of the hydrosilylation-curable silicone composition provided by an embodiment of the present invention. In some embodiments, the present invention provides a method of treating a silicone elastomer, wherein the silicone elastomer is at least part of a membrane, wherein the silicone elastomer includes a reaction product of the hydrosilylation-curable composition of the present invention or from another composition, to provide a treated membrane. In some embodiments, the present invention provides a membrane formed on a porous substrate wherein the porous substrate comprises a silicone elastomer treated by the method of surface treatment provided by embodiments of the present invention, wherein in some embodiments the silicone elastomer includes a reaction product of the hydrosilylation-curable silicone composition provided by embodiment of the present invention, and wherein in other embodiments the silicone elastomer is derived from other compositions. Embodiments of the membrane provided by the present invention can be any suitable membrane, and can be supported or unsupported, for example.

In one embodiment, the present invention provides a method of forming a membrane. The present invention can include the step of forming a membrane. The membrane can be formed on at least one surface of a substrate. For any membrane to be considered “on” a substrate, the membrane can be attached (e.g. adhered) to the substrate, or be otherwise in contact with the substrate without being adhered. The substrate can have any surface texture, and can be porous or non-porous. The substrate can include surfaces that are not coated with a membrane by the step of forming a membrane. All surfaces of the substrate can be coated by the step of forming a membrane, one surface can be coated, or any number of surfaces can be coated.

The step of forming a membrane can include two steps. In the first step, the composition that forms the membrane can be applied to at least one surface of the substrate. In the second step, the applied composition that forms the membrane can be cured to form the membrane. In some embodiments, the curing process of the composition can begin before, during, or after application of the composition to the surface. The curing process transforms the composition that forms the membrane into the membrane. The composition that forms the membrane can be in a liquid state. The membrane can be in a solid state.

The composition that forms the membrane can be applied using conventional coating techniques, for example, immersion coating, die coating, blade coating, extrusion, curtain coating, drawing down, solvent casting, spin coating, dipping, spraying, brushing, roll coating, extrusion, screen-printing, pad printing, or inkjet printing.

Curing the composition that forms the membrane can include the addition of a curing agent or initiator such as, for example, a hydrosilylation catalyst. In some embodiments, the curing process can begin immediately upon addition of the curing agent or initiator. The addition of the curing agent or initiator may not begin the curing process immediately, and can require additional curing steps. In other embodiments, the addition of the curing agent or initiator can begin the curing process immediately, and can also require additional curing steps. The addition of the curing agent or initiator can begin the curing process, but not bring it to a point where there composition is cured to the point of being fully cured, or of being unworkable. Thus, the curing agent or initiator can be added before or during the coating process, and further processing steps can complete the cure to form the membrane. Curing the composition that forms the membrane can include a variety of methods, including exposing the polymer to ambient temperature, elevated temperature, moisture, or radiation. In some embodiments, curing the composition can include combination of methods.

The membrane of the present invention can have any suitable thickness. In some examples, the membrane has a thickness of from about 1 μm to about 20 μm, about 0.1 μm to about 200 μm, or about 0.01 μm to about 2000 μm. Before, during, or after the curing process, the thickness or shape of the composition can be altered via any suitable means, for example leveled or otherwise adjusted, such that the membrane that results after the curing process has the desired thickness and shape. In one example, a doctor blade or drawdown bar is used to adjust the thickness of the applied composition. In another example, a conical die is used to adjust the thickness of the applied composition on a fiber that is later removed.

The membrane of the present invention can be selectively permeable to one substance over another. In some embodiments, membranes of the present invention derived from the hydrosilylation-curable composition including Components (A), (B), and (B) can have a CO₂ permeation coefficient of at least about 50 Barrer, 100 Barrer, 1000 Barrer, 2800 Barrer, or at least about 3500 Barrer. The membrane can have an ideal CO₂/N₂ selectivity of at least about 4, 6, 8, 10, or at least about 12. In some examples, the membrane has a CO₂/CH₄ selectivity of at least about 2, 3, 4, 5 or at least about 7. In some examples, the membrane has a water vapor permeability coefficient at 25° C. of at least about 2,500 Barrer, 5,000 Barrer, at least about 10,000 Barrer, or at least 20,000 Barrer.

The membrane of the present invention can have any suitable shape. In some examples, the membrane of the present invention is a plate-and-frame membrane, a spiral wound membrane, a tubular membrane, a capillary fiber membrane or a hollow fiber membrane. The membrane can be a continuous or discontinuous layer of material.

### Supported Membrane

In some embodiments of the present invention, the membrane is supported on a porous or highly permeable non-porous substrate. The substrate can be any suitable substrate. A supported membrane has the majority of the surface area of at least one of the two major sides of the membrane contacting a porous or highly permeable non-porous substrate. A supported membrane on a porous substrate can be referred to as a composite membrane, where the membrane is a composite of the membrane and the porous substrate. The porous substrate on which the supported membrane is located can allow gases to pass through the pores and to reach the membrane. The supported membrane can be attached (e.g. adhered) to the porous substrate. The supported membrane can be in contact with the substrate without being adhered. The porous substrate can be partially integrated, fully integrated, or not integrated into the membrane.

The porous substrate can be, for example, a filter, or any substrate of any suitable shape that includes a fibrous structure or any structure. The porous substrate can be woven or non-woven. The porous substrate can be a frit. The porous substrate can be any suitable porous material known to one of skill in the art, in any shape. For example, the at least one surface can be flat, curved, or any combination thereof. The surface can have any perimeter shape. The porous substrate can have any number of surfaces, and can be any three-dimensional shape. Examples of three-dimensional shapes include cubes, spheres, cones, and planar sections thereof with any thickness, including variable thicknesses, and porous hollow fibers. The porous substrate can have any number of pores, and the pores can be of any size, depth, shape, and distribution. In one example, the porous substrate has a pore size of from about 0.2 nm to about 500 mm. The at least one surface can have any number of pores.

### Unsupported Membrane

In some embodiments of the present invention, the membrane is unsupported, also referred to as free-standing. The majority of the surface area on each of the two major sides of a membrane that is free-standing is not contacting a substrate, whether the substrate is porous or not. In some embodiments, a membrane that is free-standing can be 100% unsupported. A membrane that is free-standing can be supported at the edges or at the minority (e.g. less than 50%) of the surface area on either or both major sides of the membrane. The support for a free-standing membrane can be a porous substrate or a nonporous substrate. Examples of suitable supports for a free-standing membrane can include any examples of supports given in the above section Supported Membrane. A free-standing membrane can have any suitable shape, regardless of the percent of the free-standing membrane that is supported. Examples of suitable shapes for free-standing membranes include, for example, squares, rectangles, circles, tubes, cubes, spheres, cones, and planar sections thereof, with any thickness, including variable thicknesses.

In examples that include a substrate, the substrate can be porous or nonporous. The substrate can be any suitable material, and can be any suitable shape or size, including planar, curved, solid, hollow, or any combination thereof. Suitable materials for porous or nonporous substrates include any polymers described above as suitable for use as porous substrates in supported membranes. The substrate can be a water soluble polymer that is dissolved by purging with water. The substrate can be a fiber or hollow fiber, as described in U.S. Pat. No. 6,797,212 B2. In some examples, the substrate is coated with a material prior to formation of the membrane that facilitates the removal of the membrane once formed. The material that forms the substrate can be selected to minimize sticking between the membrane and the substrate. In some examples, the membrane can be heated, cooled, washed, etched or otherwise treated to facilitate removal from the substrate. In other examples, air pressure can be used to facilitate removal of the membrane from the substrate.

### Method of Separating Gas Components

The present invention also provides a method of separating gas or vapor components in a feed gas mixture by use of the membrane described herein. The method includes contacting a first side of a membrane with a feed gas mixture to produce a permeate gas mixture on a second side of the membrane and a retentate gas mixture on the first side of the membrane. The permeate gas mixture is enriched in the first gas component. The retentate gas mixture is depleted in the first gas component. The membrane can include any suitable membrane as described herein. In some examples, the permeate gas mixture comprises carbon dioxide and the feed gas mixture includes at least one of nitrogen and methane. In some examples, the permeate gas mixture comprises water vapor and the feed gas mixture includes at least one of nitrogen and CO₂.

The membrane can be free-standing or supported by a porous or permeable substrate. In some embodiments, the pressure on either side of the membrane can be about the same. In other embodiments, there can be a pressure differential between one side of the membrane and the other side of the membrane. For example, the pressure on the retentate side of the membrane can be higher than the pressure on the permeate side of the membrane. In other examples, the pressure on the permeate side of the membrane can be higher than the pressure on the retentate side of the membrane.

The feed gas mixture can include any mixture of gases or vapors. For example, the feed gas mixture can include hydrogen, carbon dioxide, nitrogen, ammonia, methane, water vapor, hydrogen sulfide, or any combination thereof. The feed gas can include any gas or vapor known to one of skill in the art. The membrane can be selectively permeable to any one gas in the feed gas, or to any of several gases in the feed gas. The membrane can be selectively permeable to all but any one gas in the feed gas.

Any number of membranes can be used to accomplish the separation. For example, one membrane can be used. The membranes can be manufactured as flat sheets or as fibers and can be packaged into any suitable variety of modules including hollow fibers, sheets or arrays of hollow fibers or sheets. Common module forms include hollow fiber modules, spiral wound modules, plate-and-frame modules, tubular modules and capillary fiber modules.

The present invention can be better understood by reference to the following examples which are offered by way of illustration. The present invention is not limited to the examples given herein. Parts are given in parts by weight, unless otherwise indicated.

### REFERENCE EXAMPLE 1

### Attenuated Total Reflectance Infrared (ATR-IR) Spectroscopy

Samples were tested at ambient laboratory conditions using a Nicolet 6700 FTIR equipped with a Smart Miracle accessory having a zinc selenide crystal. Samples soaked in water were first blotted completely dry with a Kimwipe and in some cases blown dry with compressed air or nitrogen before being placed with the surface exposed to air during curing face-down on the crystal and brought into light contact with a clamp. Data acquisition was conducted within 5 minutes of removal from solution. The contact pressure was kept to the minimum needed to establish complete crystal contact, as judged by previewing the spectral quality. Comparison of Si—H and Si—OH peak heights (around 2160 cm⁻¹ and broad signal around 3390 cm⁻¹, respectively) among samples was done with identical baseline points and normalized by a suitable internal reference peak for the asymmetric CH₃ deformation at 1446 cm⁻¹. Relative concentrations over water exposure time were reported by then taking the ratio to the original data point at time zero (prior to exposure to a solution).

### REFERENCE EXAMPLE 2

### Parallel Plate Rheology

Uncured samples were transferred from a sealed container to the gap between two 8 mm diameter parallel plates pre-heated at 70° C. in a TA Instruments ARES 4400 strain controlled rheometer and compressed to a final gap of 1.5 mm at room temperature. Excess sample was trimmed with a razor blade, then heated promptly in the environmental chamber to a temperature of 120° C. with the autotension feature activated to maintain a constant normal force during heating. The samples were allowed to complete in-situ curing for 1 hour at 120° C. then cooled back to 25° C. under autotension. A frequency sweep was then conducted at 25° C. on the cured sample at a strain of 5% to determine its plateau dynamic storage modulus.

### EXAMPLE 1

In a polypropylene mixing cup was combined 10.60 g of a Part A (prepared by mixing about 67.9 parts dimethylvinylsiloxy-terminated polydimethylsiloxane having a viscosity of about 2 Pa·s at 25° C., about 32 parts of organopolysiloxane resin consisting essentially of CH₂═CH(CH₃)₂SiO_{1/2} units, (CH₃)₃SiO_{1/2} units, and SiO_{4/2} units, wherein the mole ratio of CH₂═CH(CH₃)₂SiO_{1/2} units and (CH₃)₃SiO_{1/2} units combined to SiO_{4/2} units is about 0.7, and the resin has weight-average molecular weight of about 22,000, a polydispersity of about 5, and contains about 1.8% by weight (about 5.5 mole %) of vinyl groups, and about 0.1 parts of Karstedt's catalyst) and 1.06 g of a Part B prepared by mixing 26 parts of a dimethylvinylsiloxy-terminated polydimethylsiloxane having a viscosity of about 2 Pa·s at 25° C., 12 parts of organopolysiloxane resin consisting essentially of CH₂═CH(CH₃)₂SiO_{1/2} units, (CH₃)₃SiO_{1/2} units, and SiO_{4/2} units, wherein the mole ratio of CH₂═CH(CH₃)₂SiO_{1/2} units and (CH₃)₃SiO_{1/2} units combined to SiO_{4/2} units is about 0.7, and the resin has weight-average molecular weight of about 22,000, a polydispersity of about 5, and contains about 1.8% by weight (about 5.5 mole %) of vinyl groups, 60 parts of a polydimethylsiloxane-polyhydridomethylsiloxane copolymer having an average viscosity of about 0.005 Pa·s at 25° C. and including 0.8 wt % H in the form of SiH, and 2 parts tetramethyltetravinyltetracyclosiloxane. The contents were mixed for two 30 s cycles in a Hauschild rotary mixer with a manual spatula mixing step between cycles. The sample was cast into a film by drawing down with a 6 mil doctor blade onto a fluorosilicone-coated Mylar release liner and cured for 1 h at 100° C. in a forced air convection oven.

### EXAMPLE 2

Part A of a 2-part siloxane composition was prepared by combining a mixture including 99.6 parts of dimethylvinylsiloxy-terminated polydimethylsiloxane having a viscosity of about 55 Pa·s at 25° C. (PDMS1) and 0.4 parts of a catalyst (Catalyst 1) including a mixture of 1% of a platinum(IV) complex of 1,1-diethenyl-1,1,3,3-tetramethyldisiloxane, 92% of dimethylvinylsiloxy-terminated polydimethylsiloxane having a viscosity of about 0.45 Pa·s at 25° C., and 7% of tetramethyldivinyldisiloxane. The Part A was mixed in a Hauschild rotary mixer for two 40 s mixing cycles, with a manual spatula mixing step between the first two cycles. Part B of the 2-part siloxane composition was prepared in a similar manner by combining 44.5 parts of PDMS 1, 55.1 parts of trimethylsiloxy-terminated polyhydridomethylsiloxane polymer (PHMS 1) having a viscosity of about 0.30 Pa·s at 25° C., and 0.4 parts of 2-methyl-3-butyn-2-ol. 5 parts each of Part A and Part B described in Example 1 were combined in a polypropylene cup and mixed with a Hauschild rotary mixer for two 40 s cycles with a manual spatula mixing step in-between cycles. The composition was drawn into a film with 4, 6 and 10 mil doctor blades onto fluorosilicone-coated Mylar release liner and cured for 30 min at 150° C.

### EXAMPLE 3

A section of the film prepared in Example 1 was placed in a clean polystyrene Petri dish containing 100% deionized water at room temperature (21° C.) and allowed to soak for the durations specified in Table 1. The film were then removed and analyzed by ATR-I R by the method of Reference Example 1, and returned to the solution for further treatment.

### EXAMPLE 4

A section of the film prepared in Example 1 was placed in a clean polystyrene Petri dish containing a dilute solution of chloroplatinic acid catalyst solution in deionized water at room temperature (21° C.) and allowed to soak for the durations specified in Table 1. The chloroplatinic acid catalyst solution had been prepared previously by dissolving chloroplatinic acid in isopropanol to a concentration of 1.0 wt % Pt. The final concentration of Pt was 75 ppm by weight relative to water. The film was then removed and analyzed by ATR-IR by the method of Reference Example 1 and returned to the solution for further treatment.

### EXAMPLE 5

A section of the film prepared in Example 1 was placed in a clean polystyrene Petri dish containing a dilute solution of chloroplatinic acid catalyst solution of Example 4 in deionized water at room temperature (21° C.) and allowed to soak for the durations of time specified in Table 1. The final concentration of Pt was 150 ppm by weight relative to water. The film was then removed and analyzed by ATR-IR by the method of Reference Example 1 and returned to the solution for further treatment.

### EXAMPLE 6

A section of the film prepared in Example 1 was placed in a clean polystyrene Petri dish containing a dilute solution of chloroplatinic acid catalyst solution of Example 4 in deionized water at room temperature (21° C.) and allowed to soak for the durations specified in Table 1. The final concentration of Pt was 300 ppm by weight relative to water. The film was then removed and analyzed by ATR-IR by the method of Reference Example 1 and returned to the solution for further treatment.

### EXAMPLE 7

A section of the film prepared in Example 2 was placed in clean polystyrene Petri dish containing 100% deionized water at room temperature (21° C.) and allowed to soak for the amount of durations specified in Table 1. The film was then removed and analyzed by ATR-IR by the method of Reference Example 1 and returned to the solution for further treatment.

### EXAMPLE 8

A section of the film prepared in Example 2 was placed in clean polystyrene Petri dish containing a dilute solution of chloroplatinic acid catalyst solution of Example 4 in deionized water at room temperature (21° C.) and allowed to soak for the durations specified in Table 1. The final concentration of Pt was 10 ppm by weight relative to water. The film was then removed and analyzed by ATR-IR by the method of Reference Example 1 and returned to the solution for further treatment.

### EXAMPLE 9

A section of the film prepared in Example 2 was placed in clean polystyrene Petri dish containing a dilute solution of chloroplatinic acid catalyst solution of Example 4 in deionized water at room temperature (21° C.) and allowed to soak for the durations specified in Table 1. The final concentration of Pt was 100 ppm by weight relative to water. The film was then removed and analyzed by ATR-IR by the method of Reference Example 1 and returned to the solution for further treatment.

### EXAMPLE 10

A section of the film prepared in Example 2 was placed in clean polystyrene Petri dish containing a dilute solution of chloroplatinic acid catalyst solution of Example 4 in deionized water at room temperature (21° C.) and allowed to soak for the durations specified in Table 1. The final concentration of Pt was 300 ppm by weight relative to water. The film was then removed and analyzed by ATR-IR by the method of Reference Example 1 and returned to the solution for further treatment.

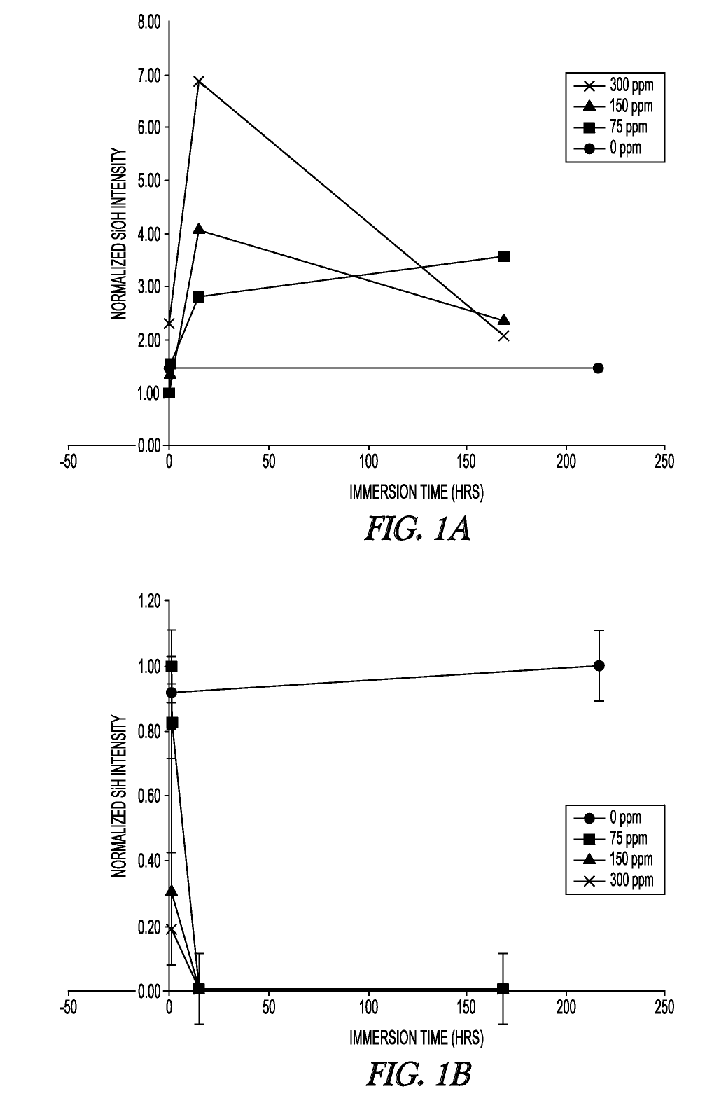

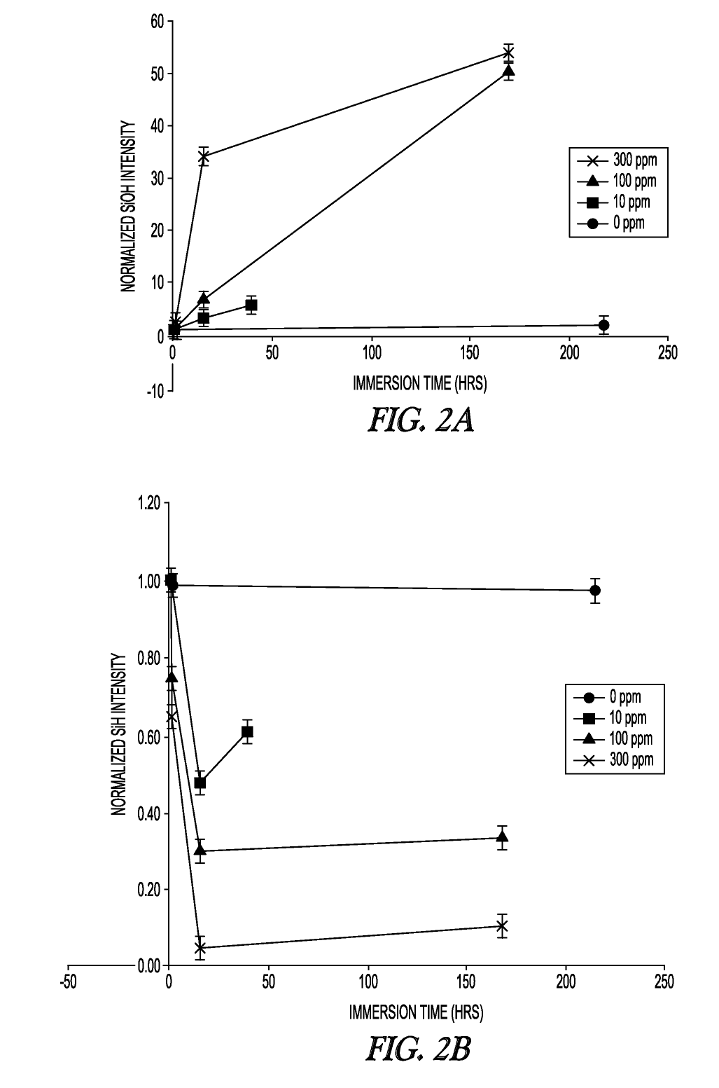

As summarized in the results of Table 1 and FIGS. 1 and 2, the embodiments of Examples 3-10 experienced a significant development of Si—OH groups on the surface of the elastomers generated in Examples 1 and 2 with concurrent reduction of Si—H groups. FIG. 1a illustrates a plot of data from Table 1 showing development of Si—OH groups and the disappearance of SiH groups on the surface of the siloxane elastomer of Example 1 with exposure time in aqueous solutions containing various levels of Pt catalyst. FIG. 1b illustrates a plot of data from Table 1 showing development of Si—OH groups and the disappearance of Si—H groups on the surface of the siloxane elastomer of Example 1 with exposure time in aqueous solutions containing various levels of Pt catalyst. FIG. 2a illustrates a plot of data from Table 1 showing development of Si—OH groups and the disappearance of Si—H groups on the surface of the siloxane elastomer of Example 2 with exposure time in aqueous solutions containing various levels of Pt catalyst. FIG. 2b illustrates a plot of data from Table 1 showing development of Si—OH groups and the disappearance of Si—H groups on the surface of the siloxane elastomer of Example 2 with exposure time in aqueous solutions containing various levels of Pt catalyst.

TABLE 1
Summary of Infrared Analysis of Soaked Samples

| | | | | Peak (cm⁻¹): | | | | | | |
|---|---|---|---|---|---|---|---|---|---|---|
| | | Pt | | 1448 | 2156 | 3460 | | | | |
| | Initial | Concentration | Immersion | Group: | | | | | | |
| Exam- | Siloxane | in water | Time | Absorbance | Absorbance | Absorbance | Ratio | Normalized | Ratio | Normalized |
| ple # | Sample | (ppm) | (h) | Si—Me | SiH | SiOH | SiH/SiMe | SiH | SiOH/SiMe | SiOH |
| 3 | Example 1 | 0 | 0 | 0.0059 | 0.0019 | 0.0008 | 0.322 | 1.00 | 0.136 | 1.00 |
| | | | 1 | 0.0061 | 0.0018 | 0.001 | 0.295 | 0.92 | 0.164 | 1.21 |
| | | | 216 | 0.0059 | 0.0019 | 0.0014 | 0.322 | 1.00 | 0.237 | 1.75 |
| 4 | Example 1 | 75 | 0 | 0.0058 | 0.0016 | 0.0008 | 0.276 | 1.00 | 0.138 | 1.00 |
| | | | 1 | 0.0057 | 0.0013 | 0.0012 | 0.228 | 0.83 | 0.211 | 1.53 |
| | | | 15 | 0.0057 | 0 | 0.0022 | 0.000 | 0.00 | 0.386 | 2.80 |
| | | | 168 | 0.0055 | 0 | 0.0027 | 0.000 | 0.00 | 0.491 | 3.56 |
| 5 | Example 1 | 150 | 0 | 0.0058 | 0.0016 | 0.0008 | 0.276 | 1.00 | 0.138 | 1.00 |
| | | | 1 | 0.0058 | 0.0005 | 0.0011 | 0.086 | 0.31 | 0.190 | 1.38 |
| | | | 15 | 0.0057 | 0 | 0.0032 | 0.000 | 0.00 | 0.561 | 4.07 |
| | | | 168 | 0.0058 | 0 | 0.0019 | 0.000 | 0.00 | 0.328 | 2.38 |
| | | | | | Samples with 0 peak intensity were below the detection limit estimated at 0.0005. | | | | | |
| 6 | Example 1 | 300 | 0 | 0.0058 | 0.0016 | 0.0008 | 0.276 | 1.00 | 0.138 | 1.00 |
| | | | 1 | 0.0057 | 0.0003 | 0.0018 | 0.053 | 0.19 | 0.316 | 2.29 |
| | | | 15 | 0.0057 | 0 | 0.0054 | 0.000 | 0.00 | 0.947 | 6.87 |
| | | | 168 | 0.0058 | 0 | 0.0017 | 0.000 | 0.00 | 0.293 | 2.13 |
| | | | | | Samples with 0 peak intensity were below the detection limit estimated at 0.0005. | | | | | |
| | | | | Peak (cm⁻¹): | | | | | | |
| | | | | 1446 | 2168 | 3386 | | | | |
| | | | | Group: | | | | | | |
| | | | | Absorbance | Absorbance | Absorbance | Ratio | Normalized | Ratio | Normalized |
| | | | | Si—Me | SiH | SiOH | SiH/SiMe | SiH | SiOH/SiMe | SiOH |
| 7 | Example 2 | 0 | 0 | 0.0051 | 0.0159 | 0.0004 | 3.118 | 1.00 | 0.078 | 1.00 |
| | | | 1 | 0.0052 | 0.016 | 0.0006 | 3.077 | 0.99 | 0.115 | 1.47 |
| | | | 216 | 0.0051 | 0.0155 | 0.0006 | 3.039 | 0.97 | 0.118 | 1.50 |
| 8 | Example 2 | 10 | 0 | 0.0044 | 0.0189 | 0.0015 | 4.295 | 1.00 | 0.341 | 1.00 |
| | | | 15 | 0.0046 | 0.0094 | 0.0055 | 2.043 | 0.48 | 1.196 | 3.51 |
| | | | 39 | 0.0041 | 0.0107 | 0.0081 | 2.610 | 0.61 | 1.976 | 5.80 |
| 9 | Example 2 | 100 | 0 | 0.0048 | 0.0189 | 0.0015 | 3.938 | 1.00 | 0.313 | 1.00 |
| | | | 1 | 0.0046 | 0.0135 | 0.0014 | 2.935 | 0.75 | 0.304 | 0.97 |
| | | | 15 | 0.0045 | 0.0053 | 0.0091 | 1.178 | 0.30 | 2.022 | 6.47 |
| | | | 168 | 0.0035 | 0.0046 | 0.0553 | 1.314 | 0.33 | 15.800 | 50.56 |
| 10 | Example 2 | 300 | 0 | 0.0048 | 0.0189 | 0.0015 | 3.938 | 1.00 | 0.313 | 1.00 |
| | | | 1 | 0.0042 | 0.0107 | 0.0034 | 2.548 | 0.65 | 0.810 | 2.59 |
| | | | 15 | 0.0048 | 0.0009 | 0.0514 | 0.188 | 0.05 | 10.708 | 34.27 |
| | | | 168 | 0.0036 | 0.0015 | 0.0608 | 0.417 | 0.11 | 16.889 | 54.04 |

Samples with 0 peak intensity were below the detection limit estimated at 0.0005.

### EXAMPLE 11

Part A of a 2-part siloxane composition was prepared by combining a mixture including 97.48 parts of siloxane-silsesquioxane blend (Blend 1) consisting essentially of 73 parts of dimethylvinylsiloxy-terminated polydimethylsiloxane having a viscosity of about 55 Pa·s at 25° C. and 27 parts of organopolysiloxane resin consisting essentially of CH₂═CH(CH₃)₂SiO_{1/2} units, (CH₃)₃SiO_{1/2} units, and SiO_{4/2} units, wherein the mole ratio of CH₂═CH(CH₃)₂SiO_{1/2} units and (CH₃)₃SiO_{1/2} units combined to SiO_{4/2} units is about 0.7, and the resin has weight-average molecular weight of about 22,000, a polydispersity of about 5, and contains about 1.8% by weight (about 5.5 mole %) of vinyl groups, and 2.05 parts of an oligomeric dimethylsiloxane(D)-methylvinylsiloxane(D^{Vi}) diol (MV Diol) having a D:D^{Vi} ratio of about 1 and a viscosity of about 0.02 Pa·s at 25° C., and 0.47 parts of a catalyst (Catalyst 1) including a mixture of 1% of a platinum(IV) complex of 1,1-diethenyl-1,1,3,3-tetramethyldisiloxane, 92% of dimethylvinylsiloxy-terminated polydimethylsiloxane having a viscosity of about 0.45 Pa·s at 25° C., and 7% of tetramethyldivinyldisiloxane.

The Part A was mixed in a Hauschild rotary mixer for two 30 s mixing cycles, with a manual spatula-mixing step between the first two cycles. Part B of the 2-part siloxane composition was prepared in a similar manner by combining 51.77 parts of Blend 1, 45.36 parts of trimethylsiloxy-terminated polyhydridomethylsiloxane polymer (PHMS 1) having a viscosity of about 0.24 Pa·s at 25° C., and 2.56 parts of a polydimethylsiloxane-polyhydridomethylsiloxane copolymer having an average viscosity of about 0.03 Pa·s at 25° C. and including 1 wt % H in the form of SiH (PDMS-PHMS) and 0.31 parts of 2-methyl-3-butyn-2-ol. 3.5 parts of Part A and 6.4 parts of Part B were then combined in a polypropylene cup and mixed with a Hauschild rotary mixer for two 40 s cycles with a manual spatula mixing step in between cycles. The composition was de-aired for about 5 minutes in a vacuum chamber at a pressure of <50 mm Hg, then drawn into films with a 20 mil doctor blade onto clean glass slides and cured for 45 to 60 min at 150° C.

### EXAMPLE 11b

A surface treating solution comprising a dilute solution of chloroplatinic acid in deionized water with a concentration of 150 ppm Pt by weight relative to water was prepared (Solution A). A rubber stamp with the letters “Dow Corning Proprietary” was wetted by pressing the stamp gently into a polystyrene Petri dish whose bottom was covered with a film of Solution A. The wetted stamp was then promptly pressed into contact with the surface of a film prepared in Example 11 that was resting on flat surface at room temperature and left in contact for approximately 4.5 hours. After removing the stamp and rinsing the entire surface of the film with deionized water, the surface was marked using horizontal lines drawn with a blue water-soluble felt-tip marker (Sanford Vis-à-vis wet erase). The blue ink dewet from the surrounding areas of the elastomer, but clearly wetted the patterned letters to reveal the stamped letters in blue ink. The ink could be washed off with water, then the process repeated several times without losing resolution of the blue letters upon re-inking.

### EXAMPLE 11c

The surface of the substrate used in Example 11b was washed with water to remove the water-soluble blue ink, then was marked with a series of horizontal lines were drawn on the surface with a permanent (non-water soluble) black marker (Sanford Sharpie). The black ink dewet from the surrounding areas of the elastomer, but remained wetted in the areas where the letters had been defined by the stamp to reveal the outline of the pattern in black. The ink pattern resisted washing by water.

### EXAMPLE 12

Part A of a 2-part siloxane composition was prepared by combining a mixture including 94.98 parts of Blend 1, 4.47 parts of MV Diol, and 0.56 parts of Catalyst 1. The Part A was mixed in a Hauschild rotary mixer for two 30 s mixing cycles, with a manual spatula mixing step between the first two cycles. Part B of the 2-part siloxane composition was prepared in a similar manner by combining 32.16 parts of Blend 1, 65.98 parts of PHMS 1, 1.59 parts of PDMS-PHMS, and 0.28 parts of 2-methyl-3-butyn-2-ol. 5.24 parts of Part A and 14.76 parts of Part B were then combined in a polypropylene cup and mixed with a Hauschild rotary mixer for two 40 s cycles with a manual spatula-mixing step in between cycles. The composition was de-aired for 5 minutes in a vacuum chamber at a pressure of <50 mm Hg, then drawn into films with a 20 mil doctor blade onto clean glass slides and cured for 45 to 60 min at 150° C.

### EXAMPLE 13

A surface treating solution (Solution 1) was prepared by combining 1.00 part of undecylenic acid (Aldrich) and 0.014 parts of Catalyst 1 in a ¼-ounce polypropylene mixing cup and mixed for two 30 s mixing cycles in a Hauschild rotary mixer.

### EXAMPLE 14

A rubber stamp with the letters “DOW CORNING PROPRIETARY” was wetted by pressing the stamp gently into a polystyrene Petri dish whose bottom was covered with a film of Solution 1. The wetted stamp was then promptly pressed into contact with the surface of a film prepared in Example 12 that was resting on a hot plate set to 100° C. The stamp was left in contact throughout the heating period of 1 hour. After about 1 hour, the glass slide-supported film was removed from the hot plate, and the stamp was gently detached. A translucent impression of the letters could be seen on the surface of the elastomer in the area where the stamp was in contact.

The bottom half of the substrate around the letters “PROPRIETARY” was then gently marked using horizontal lines drawn with a blue water-soluble felt-tip marker (Sanford Vis-à-vis wet erase). The blue ink dewet from the surrounding areas of the elastomer, but clearly wetted the patterned letters to reveal the stamped letters in blue ink. The ink could be washed off with water, then the process repeated several times without losing resolution of the blue letters upon re-inking, similarly to the embodiment described in Example 11b, describing a hot stamped pattern on the elastomer exposed by a water-based marker in an embodiment of the present invention.

### EXAMPLE 15

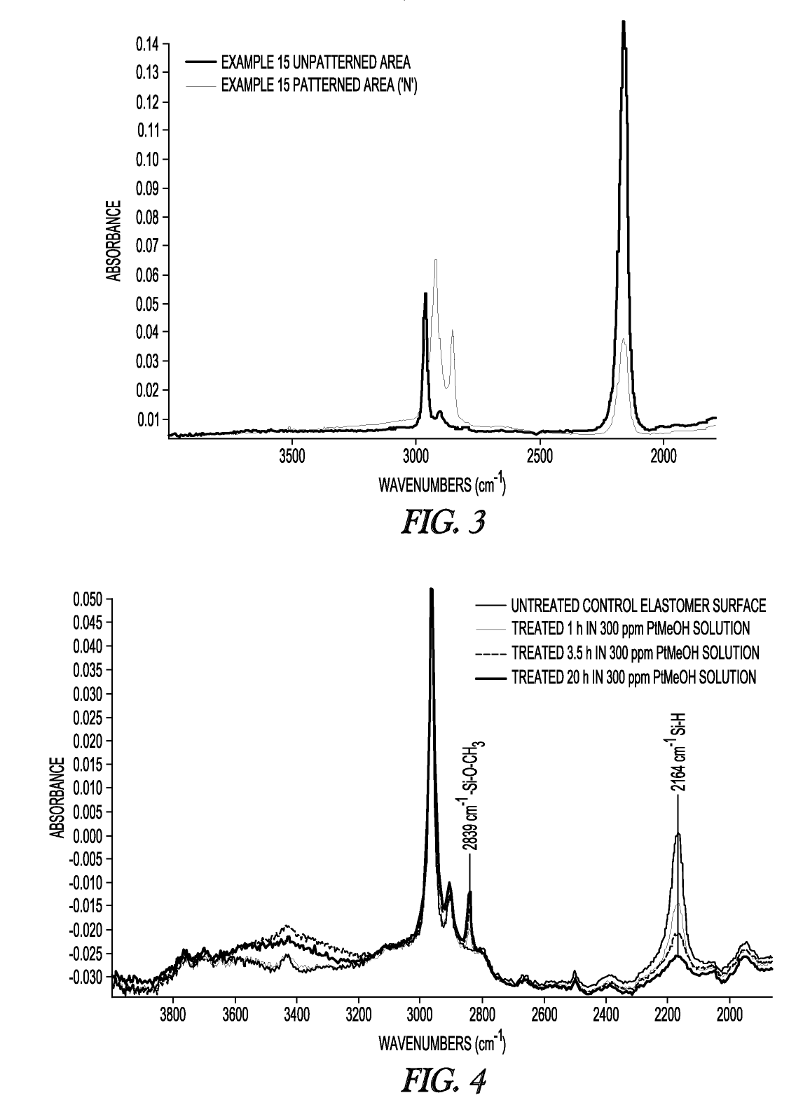

The surface of the film from Example 14 around the top half of the pattern with the unlinked letters “DOW CORNING” was rinsed with water a few times, blotted and air-blown dry then studied by the ATR-IR method of Reference Example 1. The unstamped area away from the letters showed a strong Si—H signal around 2160 cm⁻¹. The stamped letter “N” was also examined and showed a significant reduction in this Si—H peak intensity and a strong contribution of signals from the grafted undecylenic acid (C—H near 2925 cm⁻¹ and 2854 cm⁻¹, C═O 1720 cm⁻¹), as shown in FIG. 3. After this analysis, the letters on the top half of the substrate were exposed with the blue water-soluble marker as in Example 14 and similarly revealed selective adsorption of the ink in the patterned areas to reveal the “DOW CORNING” letters. FIG. 3 shows an ATR-IR spectral overlay of elastomer surface from Example 12 in areas that were unpatterned (purple) and patterned with Solution 1 (red) showing distinct signatures of surface conversion that rendered the pattern more hydrophilic and wettable with blue ink.

### EXAMPLE 16

The elastomer formulation of Example 12 was prepared in a similar fashion but cast and cured on glass slides for only 30 min at 100° C. instead of 150° C.

### EXAMPLE 17

A glass slide-supported cured elastomer sample from Example 16 was placed on a hot plate and stamped with Solution 1 in a manner similar to that described in Example 14, but the hot plate was set to 150° C. for 1 hour before cooling back to room temperature.

### EXAMPLE 18

The cooled substrate of Example 17 was placed in a polystyrene (PS) Petri dish and then covered with a solution including 12.55 g of pyrazine solution prepared by combining 20 mmol pyrazine in ethylene glycol). To this solution was added 12.39 g of a blue Cu—SiF₆ solution prepared by combining 10 mmol of Cu(NO₃)₂.3H₂O (98%, Aldrich) and 10 mmol of (NH₄)₂SiF₆ in 30 mL of de-ionized water. The solution was covered and allowed to react for 24 hours at room temperature. Blue metal-Si-framework (MSiF) crystals were observed in the Petri dish. The glass slide was carefully removed from solution, and the surface was rinsed several times with deionized water, revealing the patterned letters in a light blue color. The pattern was then examined by an optical microscope. A dense array of crystals could be seen selectively in the lettered areas that had been treated by stamping Solution 1 in Example 17. These crystals appeared finer in size than those that were left behind in the free solution, suggesting that the crystals nucleated and grew more densely in the surface treated areas and failed to grow on the rest of the untreated elastomer. After the 24 h growth and the water rinsing, free crystals could be seen which were considerably larger in size than those seeded on the carboxylic acid-treated siloxane surface.

### EXAMPLE 19

Part A of a 2-part siloxane composition was prepared by combining a mixture including 48.78 parts of Blend 1, 48.78 parts of a dimethylvinylsiloxy terminated polydimethylsiloxane having a viscosity of about 0.25 Pa·s, and 2.44 parts of Catalyst 1. The Part A was mixed in a Hauschild rotary mixer for two 30 s mixing cycles, with a manual spatula-mixing step between the first two cycles. Part B of the 2-part siloxane composition was prepared in a similar manner by combining 99.79 parts of PHMS 1 having and 0.21 parts of 2-methyl-3-butyn-2-ol. 1 Part of Part A and about 10 parts of Part B were then combined in a polypropylene cup and mixed with a Hauschild rotary mixer for two 40 s cycles with a manual spatula-mixing step in between cycles. The composition was de-aired for 5 minutes in a vacuum chamber at a pressure of <50 mm Hg, then drawn into films with a 20 mil doctor blade onto clean glass slides and cured for 45 to 60 min at 150° C.

### EXAMPLE 20

A second surface treating solution (Solution 2) was prepared by combining 0.74 parts of Solution 1, 0.76 parts of ethylene glycol diacetate (EGDA) (Aldrich), and 0.006 parts of additional Catalyst 1 in a ¼-ounce polypropylene mixing cup and mixed for two 30 s mixing cycles in a Hauschild rotary mixer.

### EXAMPLE 21

A glass-slide supported sample of the elastomers of Example 19 were placed on a 90° C. hotplate and patterned in a similar manner as described in Examples 14 and 17 using a rubber stamp that had been wetted by contacting with a cellulose pad of a sterile Millipore PS Petri Slide (PDMA04700, Fisher Scientific) that had been soaked with Solution 1. The stamp was removed after 14 minutes of exposure on the hot plate, and the pattern rinsed with EGDA and water and dried. The ATR-IR method of Reference Example 1 showed evidence of grafting of the Solution 1, though somewhat less distinct than FIG. 3, in the patterned areas. The evidence included a significant reduction in Si—H peak intensity and a strong increase in the contribution of signals from the grafted undecylenic acid (C—H near 2925 cm⁻¹ and 2854 cm⁻¹, C═O 1720 cm⁻¹) in the patterned areas. The pattern exhibited selective adsorption of the ink in the patterned areas to reveal the “DOW CORNING” letters, though somewhat less distinct.

### EXAMPLE 22

A glass-slide supported sample of the elastomers of Example 19 were placed on a 90° C. hotplate and patterned in a similar manner as described in Example 14 and 17 using a rubber stamp that had been wetted by contacting with a cellulose pad of a sterile Millipore PS Petri Slide (PDMA04700, Fisher Scientific) that had been soaked with Solution 2. The stamp was removed after 30 minutes of exposure on the hot plate, and the pattern rinsed with EGDA and water and dried. The hot stamped pattern was readily exposed selectively by the same water-soluble blue marker that dewet from the unstamped surrounding areas.

### EXAMPLE 23

The patterened surface of the sample of Example 21 was overcoated with large drop of a 25 wt polyethyleneimine solution in water (PEI) (Lupasol PL). After allowing the PEI to sit in contact with the surface overnight, the excess PEI was removed by rinsing and wiping repeatedly with fresh deionized water and deionized water-soaked paper towels. This procedure caused the original surface pattern to become notably broader and exhibit darker pigmentation when marked with a water-soluble marker, showing the possibility to create multilayers by sequential addition of carboxylic-acid reactive compounds.

### EXAMPLE 24

A section of a film prepared according to the composition and of Example 2 but cured for 1 hour at 150° C. (rather than 30 min at 150° C.) was placed in clean polystyrene Petri dish containing a dilute solution of chloroplatinic acid catalyst solution of Example 4 in methanol at room temperature (21° C.) and allowed to soak for 1 hour. The final concentration of Pt was 300 ppm by weight relative to methanol. The film was then removed, blotted dry and allowed to sit at room temperature to allow free methanol to evaporate, then analyzed by ATR-IR by the method of Reference Example 1.

### EXAMPLE 25

A section of the same film prepared in Example 24 was treated according to the procedure described in Example 24 but allowed to soak for 3.5 hours. The final concentration of Pt was 300 ppm by weight relative to methanol. The film was then removed blotted dry and allowed to dry at room temperature for 15 minutes to allow free methanol to evaporate, and analyzed by ATR-IR by the method of Reference Example 1. The sample was allowed to dry an additional 15 min then retested by ATR-IR and no significant spectral changes, confirming stability of the surface functionalization and that the signals were not influenced by residual methanol.

### EXAMPLE 26

A section of the same film prepared in Example 24 was treated according to the procedure described in Example 24 but allowed to soak for 20 hours. The final concentration of Pt was 300 ppm by weight relative to methanol. The film was then removed blotted dry and allowed to dry at room temperature for 15 minutes to allow free methanol to evaporate, and analyzed by ATR-IR by the method of Reference Example 1. The sample was then allowed to dry an additional 15 min then retested by ATR-IR and showed no significant spectral changes, confirming stability of the surface functionalization and that the signals were not influenced by residual methanol.

The embodiments of Examples 24-26 exhibited a significant development of Si—OCH₃ groups on the surface of the elastomers generated in Examples 2 with concurrent reduction of Si—H groups as a function of treatment time by the Pt-catalyzed methanol solution. FIG. 4 shows the development of the SiOCH₃ peak (2839 cm⁻¹) and concomitant decrease of the SiH peak (2164 cm⁻¹) ATR-IR spectra of the elastomer surface before treatment, after 1 hour, and after 3.5 hours (+15 minutes drying in ambient air) and after 20 hours exposure (+15 minutes drying in ambient air) to the Pt-catalyzed methanol solution.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A hydrosilylation-curable silicone composition comprising:
(A) an organohydrogenpolysiloxane having an average of at least two silicon-bonded hydrogen atoms per molecule;
(B) a cross-linking agent selected from (i) at least one organosilicon compound having an average of at least two aliphatic unsaturated carbon-carbon bonds per molecule, (ii) at least one organic compound having an average of at least two aliphatic unsaturated carbon-carbon bonds per molecule, and (iii) mixtures comprising (i) and (ii); and
(C) a hydrosilylation catalyst; wherein a mole ratio of silicon-bonded hydrogen atoms in the composition to aliphatic unsaturated carbon-carbon bonds in the composition is at least 20:1.

2. A method of treating a surface comprising a silicone elastomer having a plurality of silicon-bonded hydrogen atoms, the method comprising:
contacting at least one region of a surface comprising a silicone elastomer having a plurality of silicon-bonded hydrogen atoms with a solution comprising a surface treatment compound to give a treated surface, wherein at least one selected from (a), (b), and (c) occurs:
(a) the contacting occurs for a time sufficient to convert at least a portion of the silicon-bonded hydrogen atoms to silicon-bonded hydroxyl groups;
(b) the contacting occurs for a time sufficient to convert at least a portion of the silicon-bonded hydrogen atoms to silicon-bonded —O—R groups, wherein the solution further comprises a compound having the formula H—O—R, wherein R is selected from C₁₋₁₅ monovalent aliphatic hydrocarbon groups, C₆₋₁₅ monovalent aromatic hydrocarbon groups, C₁₋₁₅ monovalent heteroalkyl groups, or C₁₋₁₅ monovalent heteroaryl groups, wherein R is optionally substituted with one or more halogen atoms; and
(c) the contacting occurs for a time sufficient to convert at least a portion of the silicon-bonded hydrogen atoms to silicon-bonded carbon groups, wherein the solution further comprises an unsaturated carboxylic acid or an unsaturated protected carboxylic acid;
wherein the surface treatment compound is selected from a platinum group metal, a platinum group metal-containing compound, a base, or a compound comprising Sn, Ti, or Pd;
wherein the silicone elastomer comprises a cured product of a hydrosilylation-curable silicone composition.

3. The method of claim 2, wherein the hydrosilylation-curable silicone composition comprises:
(A) an organohydrogenpolysiloxane having an average of at least two silicon-bonded hydrogen atoms per molecule;
(B) a cross-linking agent selected from (i) at least one organosilicon compound having an average of at least two aliphatic unsaturated carbon-carbon bonds per molecule, (ii) at least one organic compound having an average of at least two aliphatic unsaturated carbon-carbon bonds per molecule, and (iii) mixtures comprising (i) and (ii); and
(C) a hydrosilylation catalyst, wherein the mole ratio of silicon-bonded hydrogen atoms in Component (A) to aliphatic unsaturated carbon-carbon bonds in Component (B) is greater than about 1:1.

4. A method of making a porous or highly permeable substrate, comprising the method of claim 2, further comprising:
forming an uncured substrate that comprises the hydrosilylation-curable silicone composition; and
curing the uncured substrate, to give a substrate that comprises the cured product of the hydrosilylation-curable silicone composition;
wherein the treated surface comprises a treated substrate.

5. A method of making a membrane, comprising:
forming a coating on the substrate of the porous or highly permeable substrate of claim 4, wherein the coating comprises a curable composition; and
curing the coating, to give a membrane.

6. A method of seeding crystals, comprising the method of claim 2, further comprising:
forming an uncured substrate that comprises the hydrosilylation-curable silicone composition;
curing the uncured substrate, to give a substrate that comprises the silicone elastomer; and
seeding crystals on the treated surface.

7. A treated silicone elastomer prepared according to the method of claim 2.

8. A method of making a membrane, comprising:
forming a coating, the coating comprising the composition of claim 1; and
curing the coating, to provide a membrane.

9. A method of making a treated membrane, comprising the method of claim 2, further comprising:
forming a coating, the coating comprising the hydrosilylation-curable silicone composition; and
curing the coating, to provide a membrane that comprises the silicone elastomer;
wherein the treated surface comprises a treated membrane.

10. An unsupported membrane comprising the treated silicone elastomer according to claim 7, wherein the membrane is free-standing.

11. The unsupported membrane according to claim 10, wherein the membrane is selected from a plate membrane, a spiral membrane, tubular membrane, and hollow fiber membrane.

12. A coated substrate, comprising:
a substrate; and
a coating on the substrate, wherein the coating comprises the treated silicone elastomer according to claim 7.

13. The coated substrate according to claim 12, wherein the substrate is porous and the coating is a membrane.

14. The coated substrate according to claim 12, wherein the porous substrate is a frit comprising a material selected from glass, ceramic, alumina, and a porous polymer.

15. A method of separating gas components in a feed gas or vapor mixture, the method comprising:
contacting a first side of a membrane with a feed gas mixture comprising at least a first gas component and a second gas component to produce a permeate gas mixture on a second side of the membrane and a retentate gas mixture on the first side of the membrane;
wherein the permeate gas mixture is enriched in the first gas component,
wherein the retentate gas mixture is depleted in the first gas component,
wherein the membrane comprises a cured product of the hydrosilylation-curable composition of claim 1.

16. The method of claim 15, wherein the permeate gas mixture comprises carbon dioxide and the feed gas mixture comprises at least one of nitrogen and methane.

17. The method of claim 15, wherein the permeate gas mixture comprises water vapor and the feed gas mixture comprises at least one of nitrogen and CO₂.

18. A method of separating gas components in a feed gas or vapor mixture, the method comprising:
contacting a first side of a membrane with a feed gas mixture comprising at least a first gas component and a second gas component to produce a permeate gas mixture on a second side of the membrane and a retentate gas mixture on the first side of the membrane;
wherein the permeate gas mixture is enriched in the first gas component,
wherein the retentate gas mixture is depleted in the first gas component,
wherein the membrane comprises the treated surface of claim 2.

19. The hydrosilylation-curable silicone composition of claim 1, wherein a mole ratio of silicon-bonded hydrogen atoms in Component (A) to aliphatic unsaturated carbon-carbon bonds in Component (B) is at least 20:1.

20. The method of claim 2, wherein the platinum group metal or the platinum group metal-containing compound is provided in a concentration in the solution comprising the surface treatment compound sufficient that the solution comprises at least 1 ppm by weight of the platinum group metal.
